(19) United States
(12) Patent Application Publication
(10) Pub. No.: US 2020/0186053 A1
(43) Pub. Date: Jun. 11, 2020

(54) POWER CONVERTER

(71) Applicant: Reto Truninger, Mount Pleasant (AU)

(72) Inventor: Reto Truninger, Mount Pleasant (AU)

(21) Appl. No.: 16/608,505

(22) PCT Filed: Apr. 27, 2018
(86) PCT No.: PCT/AU2018/050388

§ 371 Date: Oct. 25, 2019

(30) Foreign Application Priority Data
Apr. 28, 2017 (AU) 2017901552

(51) Int. Cl. H02M 7/28; H02M 3/335; H02M 3/337; H02M 7/538

(52) U.S. Cl. CPC H02M 7/28; H02M 3/33523; H02M 2001/007; H02M 7/53806; H02M 3/3376

(57) ABSTRACT

A power supply device for converting an AC power input into a DC power output comprises a rectifier module connected to the AC power input for producing rectified power; a final stage DC-DC converter for producing the DC power output; and one or more smoothing stages provided between the rectifier module and the final stage DC-DC converter to smooth the rectified power. There is an initial DC-DC converter module is provided between the rectifier and one of the smoothing stages to lower the voltage range of the output signal from the rectifier. The lowered voltage range of the rectified power is provided directly to the final stage DC-DC converter, without a power storage device storing the lowered voltage range rectified power.

### FIELD OF THE INVENTION

The present invention relates to a power converter device suitable for use in charging electronic devices.

### BACKGROUND TO THE INVENTION

Devices that convert AC power to DC power for charging are commonly used for a range of different electronic devices. Such devices generally comprise a housing having pins connectable to an AC power source and an output socket or lead to connect to the device to be charged.

Given the number of such portable devices requiring charging, it would be desirable to have a charging device in a relatively compact form such that it is also easily carried for use. It would also be desirable for such a device to be able to operate on a range of AC inputs such that the device can be used in various locations.

Referring to the FIG. 1, there is shown a modular view of a known power converter of the type which may be used for converting AC power to DC power for the charging of electronic devices.

The power converter of FIG. 1 comprises a rectifier module 12 in connection with an AC power input 11. The rectifier module 12 rectifies the AC signal in preparation for conversion to a DC output signal at a DC output 13. The rectifier module 12 is connected to the input of a smoothing capacitor stage 16. The smoothing capacitor stage 16 comprises one or more smoothing capacitors provided to smooth the rectified signal output from the rectifier module 12.

The output of the smoothing capacitor stage 16 is connected to the input of a final DC-DC module 14. The final DC-DC module 14 is provided to step down the DC voltage received at its input to a level suitable for charging electronic devices via the output 13.

As part of such standard converters, capacitors are generally used to provide a smoothing function after rectification of an AC input. In order to provide a device that works at varying AC input voltages however, such capacitors generally need to be selected to provide no more than a maximum voltage drop in order to still work effectively at the lowest desired voltage range, while at the same time the capacitor voltage has to be rated to accommodate the maximum allowable input voltage. This can result in the use of larger capacitors, thereby increasing the physical dimensions of the device.

The present invention relates to a DC power supply device aimed at providing effective operation over a range of input voltages while minimising required capacitor sizes and therefore the physical size of the device.

### SUMMARY OF THE INVENTION

According to one aspect of the present invention there is provided a power supply device for converting an AC power input into a DC power output comprising:

a rectifier module connected to the AC power input for producing rectified power;
a final stage DC-DC converter for producing the DC power output; and
one or more smoothing stages provided between the rectifier module and the final stage DC-DC converter to smooth the rectified power; wherein an initial DC-DC converter module is provided between the rectifier and one of the smoothing stages to lower the voltage range of the output signal from the rectifier;
wherein the lowered voltage range of the rectified power is provided directly to the final stage DC-DC converter, without a power storage device storing the lowered voltage range rectified power.

In a specific form one of the smoothing stages is provided between the initial DC-DC converter module and the final DC-DC module. In a more specific form this smoothing stage comprises a capacitor. In an embodiment the capacitor is of a small enough value to perform voltage smoothing, but is not large enough to remain substantially charged, when the DC power output is under load and the AC power input is not supplied with an AC power input. More specifically still the power storage device is a battery.

In an embodiment one or both of the initial DC-DC converter module and the final DC-DC converter comprises galvanic isolation.

Preferably the initial DC-DC converter module comprises a buck converter.

Alternatively, the initial DC-DC convertor and/or the final DC-DC convertor comprises a flyback converter.

Alternatively, the initial DC-DC convertor and/or the final DC-DC convertor comprises a push pull converter.

Preferably the power converter is configured to receive AC power inputs over a range of levels.

Preferably the power converter is configured to operate at AC input voltages between 90 VAC and 250 VAC. Preferably the power converter is configured to produce and output voltage of 12 VDC or 5V DC.

In an embodiment one or more of the smoothing stages comprises a capacitor.

In an embodiment one of the smoothing stages is provided between the rectifier and the initial DC-DC converter. In an embodiment a smoothing stages is provided between the final DC-DC converter and the output.

According to another aspect of the invention there is provided a power supply device for converting an AC power input into a DC power output to a power consuming device; comprising:

an AC power supply that outputs AC power to a rectifier that in turn outputs rectified power;
an initial DC-DC converter module that receives the rectified power from the rectifier as an input, wherein the initial DC-DC converter module outputs a lower peak voltage than the voltage at the input;
a smoothing capacitor connected across the output of the initial DC-DC converter module, wherein the smoothing capacitor smooths the output voltage across the output of the DC-DC converter module;
a final stage DC-DC converter that receives the output of the initial DC-DC converter and further lowers the voltage output, wherein an output of the final stage DC-DC converter provided the DC power output.

According to another aspect of the invention there is provides a power supply device for converting an AC power into a DC power; comprising:

an AC power input;
a DC power output;
a rectifier for converting AC power from the AC power input into rectified power;
a first step down DC-DC converter that receives the rectified power;
a second step down DC-DC converter that provides the DC power at a desired voltage to the DC power output;
wherein output from the first step down converter is connected to input for the second step down converter only by a smoothing circuit that does not retain power over a substantial period of time after the AC power is no longer input.

In an embodiment the smoothing circuit comprises a capacitor.

In an embodiment one or both of the step down DC-DC converters provides galvanic isolation.

According to a further aspect of the invention there is provided a method of converting AC power into DC power, comprising:

receiving AC power;
rectifying the AC power;
stepping down the voltage of the rectified power;
smoothing the stepped down power;
stepping down the smoothed power to a desired DC voltage; and
outputting power at the desired DC voltage.

In an embodiment the method further comprises galvanically isolating the received AC power from the output DC power.

### BRIEF DESCRIPTION OF THE DRAWINGS

The invention will now be described, by way of example, with reference to the following drawings in which:

FIG. 1 is a modular view of a known power converter configuration;

FIG. 2 is a modular view of a power converter in accordance with an embodiment of the present invention;

FIG. 3a is a modular view of a second embodiment of a power converter in accordance with the present invention;

FIG. 3b is a modular view of a third embodiment of a power converter in accordance with the present invention;

FIG. 4a is a circuit diagram of a fourth embodiment of a power converter according to the present invention; and

FIG. 4b is a circuit diagram of a fifth embodiment of a power converter according to the present invention.

### DETAILED DESCRIPTION OF PREFERRED EMBODIMENTS

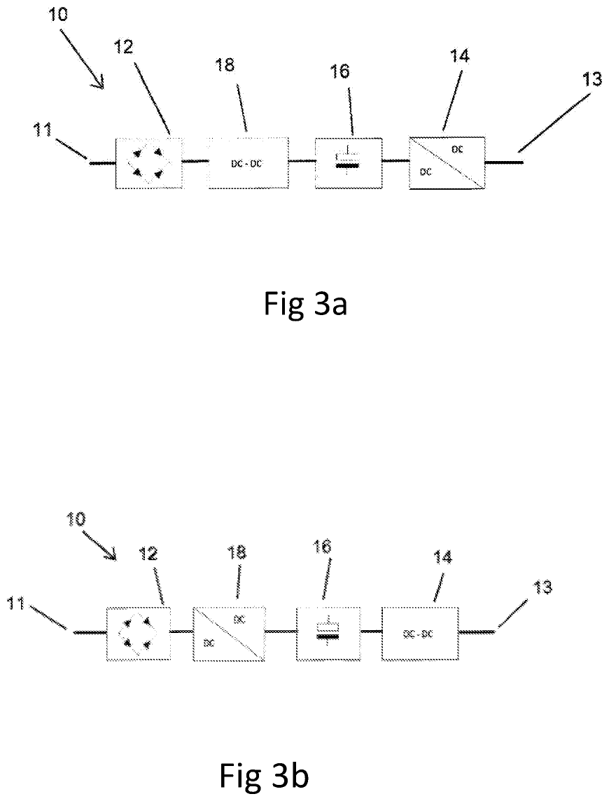

FIG. 2 shows an embodiment of a power converter 10 in accordance with the present invention. The power converter 10 is provided to receive AC power inputs over a range of levels. The power converter 10 may, for example, be configured to operate at AC input voltages between 90 VAC and 250 VAC.

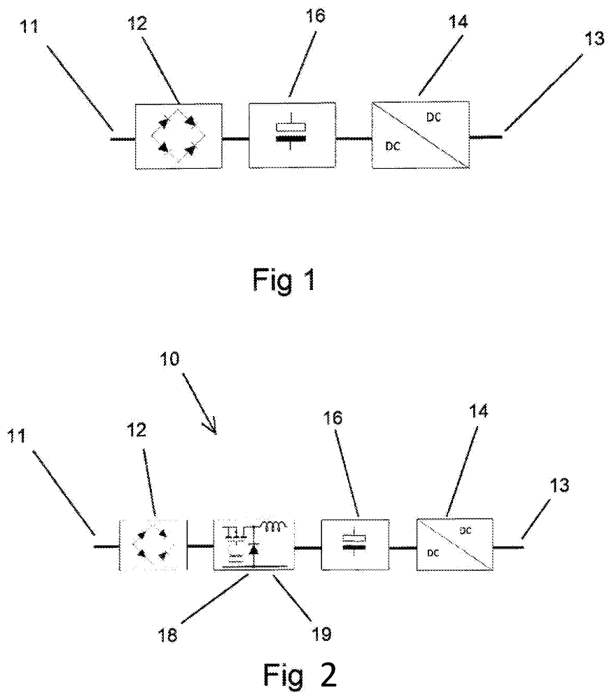

The power converter 10 is similar to the embodiment of FIG. 1 a in that it includes a rectifier 12 in connection with an AC input 11, a DC-DC converter 14 in connection with a DC output 13, and one or more capacitors in a smoothing capacitor stage 16 provided between the rectifier 12 and the DC-DC converter 14.

With such a range of expected input voltages, the capacitors selected for the smoothing capacitor stage 16 would be required to be able to limit the voltage drop between cycles of the rectified signal to a level suitable for the lowest AC input voltage. That is, the capacitors of the smoothing capacitor stage 16 would need to be sufficiently large to prevent the voltage dropping below a minimum operating voltage, while it also needs to be rated for maximum input voltage. The capacitors of the smoothing capacitor stage 16 of FIG. 1 would therefore need to be relatively large, thereby resulting in an increase in the physical size requirements for the housing containing the power converter 10.

The power converter 10 of the present invention includes also an initial DC-DC converter module 18 connected between the output of the rectifier module 12 and the input of the smoothing capacitor stage 16. The initial DC-DC converter module 18 in the embodiment of FIG. 2 comprises a buck converter 19.

The buck converter 19 reduces the voltage levels of the rectified signal from the output of the rectifier module 12 to a rectified sine voltage with a constant peak voltage, regardless of the input voltage, prior to input to the smoothing capacitor stage 16. The reduced and constant signal levels provided by the output of the buck converter 19 to the input of the smoothing capacitor stage 16 thereby lowers the maximum voltage rating for the capacitors. The capacitors of the capacitor stage 16 can therefore be chosen to accommodate the maximum peak output voltage of the buck converter 19 and are therefore reduced in size, thereby reducing the ultimate size of the housing of the power converter 10 reduced.

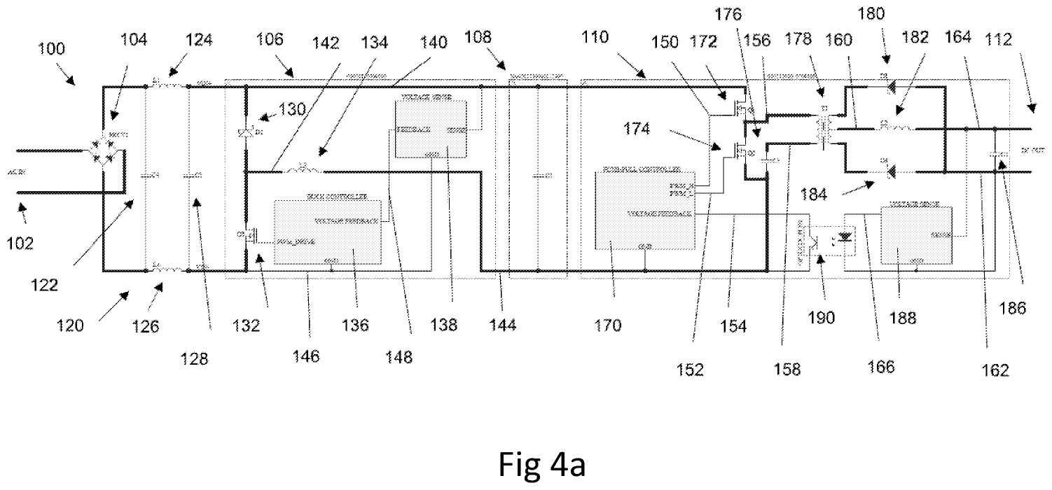

FIGS. 3a and 3b show alternative embodiments of power converters 10 in accordance with the present invention. The power converters 10 of FIGS. 3a and 3b include alternative configurations of the initial DC-DC converter modules. In FIG. 3a the galvanic isolation is done in the final stage 14. In FIG. 3b, the galvanic isolation is done in the initial stage 18.

It is noted that the initial DC-DC converter stage 18 can comprise any converter topology that lowers the input voltage to a constant peak voltage. The final DC-DC converter stage can be any topology that converts the smoothed constant voltage to the desired output voltage. At least one stage should perform the galvanic isolation. It is also noted that more stages may be utilised if further functionality is required. Example suitable topologies for the initial DC-DC converter are: Buck, SEPIC, ZETA and Cuk, non-isolating converters, and full bridge, half bridge, push pull, forward and flyback isolating converters. Example suitable topologies for the final stage DC-DC converter are buck, boost, SEPIC, ZETA and Cuk non-isolating converters, and full bridge, half bridge, push pull, forward and flyback isolating converters.

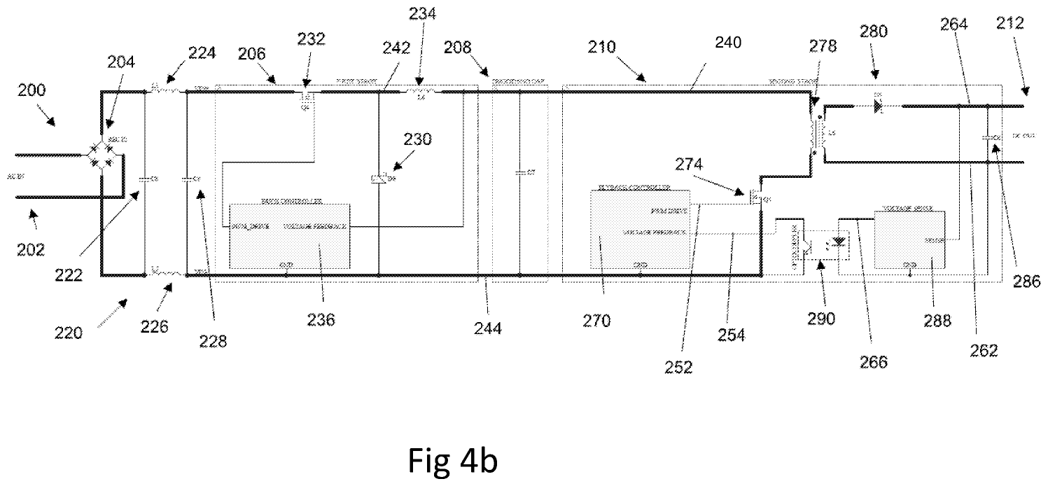

FIG. 4a shows an embodiment of the power converter 100 as illustrated in FIG. 3a. The power converter 100 receives an AC input 102, which maybe for example 110 VAC at 60 Hz or 230/240/250 VAC at 50 Hz. The AC input is received at the rectifier 104. The rectifier 104 may be a full wave diode bridge rectifier, although other types of rectifier may be used. The rectified voltage from the rectifier 104 is provided to an optional, but preferred, precursor stage 120 described further below and then to a positive conductor 140. Negative input from the rectifier 104 (via the precursor stage 120) is connected to a ground conductor 146 of the first step down DC to DC converter stage 106 for stepping down DC voltage from the precursor stage 120 to a lower DC voltage from provided to a smoothing stage 108.

The DC to DC converter stage 106 comprises a buck converter, which comprises a switch in the form of a transistor 132, a diode 130 (which may be in the form of a Shottky diode) and an inductor 134. The transistor 132 is typically a MOSFET, such as an enhancement type n-channel power MOSFET and is switched on/off by a buck controller 136. In this embodiment the buck controller 136 produces a pulse width modulation (PWM) switching signal to the gate of the MOSFET 132 at a frequency and/or mark to space ratio according to a voltage determined by a voltage sensor 138 for sensing a voltage difference across the input from the rectifier 104. The PWM signal is determined so that the switching occurs such that a desired peak step down voltage is produced by the buck converter. In other embodiments the buck controller 136 can produce another form of control signal, such as pulse frequency modulation.

When the transistor 132 is switched off, current is not returned to the rectifier 104, and the diode 130 and inductor 134 are in series (the anode of the diode 130 being connected to the inductor 134), via conductor 142. The voltage across both of these components (130, 134) forms the output of this first stage 106. That is, the output is across conductor 140 and conductor 144, which is connected in series with the diode 130 and the inductor 134. Conductor 144 is the negative output. Conductor 140 is the positive output and is connected to the cathode of diode 130.

When the transistor 132 is switched on, the conductor 142 is connected to the precursor stage 120 and current is returned from the inductor 134, via the conductor 142, to the rectifier 104 (via the precursor stage 120). The Diode 130 is reverse biased and therefore not conducting from the conductor 140 to the conductor 142. Initially, when the transistor 132 is switched on, the change in current flow through the inductor 134, to the rectifier 104, produces an opposing voltage across the terminals of the inductor 134. The voltage across inductor 134 subtracts from the voltage between conductor 140 and 142 to form the output voltage between conductor 140 and conductor 144. Also, the inductor 134 stores energy in the form of a magnetic field.

When the transistor 132 is switched off, then there will be a voltage drop across the inductor 134, so the net voltage at the output of the first stage 106 will always be less than the input voltage from the rectifier 104. Also the current decreases which produces a voltage across the inductor 134 (opposite in direction to when the transistor 132 is on), thus presenting voltage to the output of the first stage 106 in addition to the forward voltage across the diode 130, and the inductor 134 becomes a current source while the stored energy of the magnetic field supports the current flow to the output of the first stage 106. The current from the inductor 134 flows through diode 130 to conductor 144.

When the transistor 132 is switched on again before the inductor 134 fully discharges, the voltage at the output of the first stage 130 will always be more than zero.

The converted voltage from the first stage 106 inputs to the smoothing capacitor stage 108, which comprises a capacitor for smoothing the voltage between conductors 140 and 144 to be input into the second DC-DC convertor stage 110 as the capacitor is charged and discharged by the voltage from the first stage 106. This also provides the input to the step down second DC to DC converter stage 110.

The step down second DC to DC converter stage 110 comprises a push pull converter. The push pull converter comprises transistor 172, transistor 174, capacitor 176, centre tapped transformer 178, diodes 180 and 184, inductor 182, capacitor 186, voltage sensor 188, opto-coupling 190 and a push-pull controller 170.

Transistor 172 is typically a MOSFET, such as an enhancement type n-channel power MOSFET. It acts as a switch connecting the positive input from conductor 140 to conductor 156 and transistor 174. Conductor 156 connects to a terminal of the primary winding of transformer 178. Transistor 174 is typically a MOSFET, such as an enhancement type n-channel power MOSFET. It acts as a switch connecting the conductor 156 to the negative conductor 144 and capacitor 176. The other terminal of the primary windings of transformer 178 are connected to capacitor 176, such that the primary windings of transformer 178 and capacitor 176 are in series across the source and drain of the transistor 174.

Switching of the transistors 172 and 174 is controlled by a push-pull controller 170 for generating high and low pulse width modulated outputs, which are connected to the respective gate of the MOSFETs 172 and 174 so as to control whether the primary windings of the transformer 178 are connected to the positive conductor 140 (when transistor 172 is on, transistor 174 is off) and negative conductor 144, via capacitor 174, or whether the capacitor 176 is connected across the primary windings of the transformer 178 (when transistor 174 is on, transistor 172 is off) in reverse polarity. Switching is determined by the controller 170 so that the output voltage sensed by the voltage sensor 188 substantially remains at the desired output voltage of the power converter 100.

When transistor 172 is on (and transistor 174 off) (state 1) current flows through the primary windings of the transformer 178 into capacitor 176. When transistor 174 is on (and transistor 172 off) (state 2) current flows out from the capacitor 176 through the primary windings of the transformer 178, but in the reverse direction. Capacitor 176 blocks DC current and maintains the voltage on the primary winding side of the transformer 178 at half of the input voltage. Typically, it is only charged and discharged minimally thereby maintaining substantially constant voltage.

The current flow through the primary winding produces current flow in the secondary windings of the transformer 178, thus inducing a voltage across the secondary windings. The tap will be half the voltage (to either terminal of the secondary windings). The tap is connected to inductor 182, which in turn is connected to output conductor 164. Each of the secondary winding terminals is connected to the cathode of the respective diode 180, 184. The diodes 180, 184 (normally Shottky diodes) block current flow from cathode to anode while permitting current flow from anode to cathode. Other types of rectification may be used instead of the diodes.

In this manner one of the diodes 180 and 184 will be forward biased and one will be reverse biased depending on whether the voltage across the secondary windings is created by the transistor 172 being on (state 1) or the transistor 172 being on (state 2). That is, they act as a half rectifier. Capacitor 186 is connected in series with inductor 182 and the anodes of the diodes 180 and 182. The output 112 of the final stage 110 is across the capacitor 186. Tap voltage induces current flow through the inductor 182 and conductor 164 to capacitor 186 which charges the capacitor 186. The forward biased diode returns the current to the windings. Thus, the voltage across the capacitor 186 is the output voltage (of for example 5V) and current through inductor 182 (which is not being stored in the capacitor 186) or discharge of stored charge in capacitor 186 provides the current to the output 112.

The voltage across the capacitor 186 is sensed by a voltage sensor 188 and is provided via optocoupler 190 to the push pull controller 170 for controlling the pulse width modulation switching control via conductors 150 and 152 to transistors 172 and 174, respectively so as to produce either state 1 or state 2. Thus, the output voltage is maintained at the required amount by the pulse width of the signal driving the push pull MOSFETS. Inductor 182 acts as a buck inductor. The transformer 178 and the optocoupler 190 provide galvanic isolation between the input to stage 110, namely conductors 140 and 144, and the output 112 to this stage 110, namely conductors 164 and 162. The output 112 is a DC voltage controlled pulse width which is smoothed by inductor 182 and capacitor 186.

The precursor stage 120 performs electromagnetic interference (EMI) filtering. Preferably, it does not perform any 50 or 60 Hz AC smoothing. It filters high frequency EMI produced by the fast switching of the MOSFETs. It comprises capacitor 122 across the output of the rectifier 104 inductors 124 and 126 in series with each output of the rectifier 104 and capacitor 128 across the other terminals of the inductors 124 and 126. That this, the inductor 124, capacitor 128 and inductor 126 are in series, with the output of the precursor stage 120 being across the capacitor 128.

FIG. 4b shows another embodiment of the power converter 200 as illustrated in FIG. 2a. The power converter 200 receives an AC input 202, which maybe for example 110 VAC at 60 Hz or 230/240/250 VAC at 50 Hz. The AC input is received at the rectifier 204. The rectifier 204 may be a full wave diode bridge rectifier, although other types of rectifier may be used. The rectified voltage from the rectifier 204 is provided to an optional, but preferred, precursor stage 220, which is similar or the same as precursor stage 120, and then inputs to the first step down DC-DC converter stage 206. The negative from the rectifier 204 is also connected via the precursor stage 220 to a ground conductor 244 of the convertor stage 206. The DC to DC converter stage 206 comprises a buck converter, which comprises a switch in the form of a transistor 232, a diode 230 and an inductor 234. The transistor 232 is typically a MOSFET, such as an enhancement type n-channel power MOSFET and is switched on/off by a buck controller 236. The buck controller 236 produces a signal to the gate of the MOSFET 232 at a frequency and/or mark to space ratio according to a voltage sensed at the output of the first stage which is between positive conductor 240 and negative conductor 244.

The precursor stage 220 is connected to the drain of the MOSFET 232. The source of the MOSFET 232 is connected to the cathode of the diode 230 and a terminal of the inductor 234. The anode of the diode 230 connects to the negative conductor 244. The other terminal of the inductor 234 connects to the output positive conductor 240 of this stage.

When the transistor 232 is switched off, the anode of the diode 230 and the inductor are isolated from the positive output of the rectifier 204.

When the transistor 232 is switched on, the anode of the diode 230 and the inductor are connected to the positive output of the rectifier 204, via precursor stage 220. Current is provided to the inductor 234, via the conductor 242, and then to conductor 240. Initially, when the transistor 232 is switched on, the change in current flow through the inductor 234, produces an opposing voltage across the terminals of the inductor 234. This voltage across the inductor 234 subtracts form the voltage as an output to the first stage 206. Also, the inductor 234 stores energy in the form of a magnetic field.

When the transistor 232 is switched off while the current is still changing, then there will always be a voltage drop across the inductor 234, so the net voltage at the output of the first stage 206 will always be less than the input voltage from the rectifier 204. Also the current decreases which produces a voltage across the inductor 234 (opposite in direction to when the transistor 232 is on), thus presenting voltage to the output of the first stage 206, less the voltage drop across the now forward biased diode 230, and the inductor 234 becomes a current source while the stored energy of the magnetic field supports the current flow to the output of the first stage 206.

When the transistor 232 is switched on again before the inductor 234 fully discharges, the voltage at the output of the first stage 230 will always be more than zero.

The converted voltage from the first stage 206 is input to the smoothing capacitor 208, which comprises a capacitor for smoothing the voltage between conductors 240 and 244 to be input into the second DC-DC convertor stage 210 as the capacitor is charged and discharged by the voltage from the first stage 206.

The second stage step down DC to DC module 210 comprises a flyback converter, which comprises transistor 274, coupled inductor 278, diode 280, capacitor 286, voltage sensor 288, opto-coupling 290 and a flyback controller 270. Transistor 274 is typically a MOSFET, such as an enhancement type n-channel power MOSFET. The primary winding of the coupled inductor 278 is connected to the conductor 240 and to the drain of the transistor 274.

Transistor 274 acts as a switch connecting the coupled inductor 278 to the negative conductor 244, thus allowing current to flow through the primary windings of the coupled inductor 278. Switching on/off of the transistor 274 is controlled by a flyback controller 270 for generating high and low pulse width modulated outputs, which are connected to the gate of the MOSFET 274 so as to control whether the primary windings of the coupled inductor 278 are energised. When transistor 274 is off the primary windings of coupled inductor 278 are denergised. The stop of current flow through the primary winding produces current flow in the secondary windings of the coupled inductor 278, thus inducing a voltage across the secondary windings.

When the transistor 274 is switched on, current and magnetic flux in primary windings of the coupled inductor 278 increase, storing energy in the coupled inductor 278. The voltage induced in the secondary windings is reversed relative to the primary windings and therefore the diode 280 is reverse-biased. The capacitor 286 supplies energy to the output 212.

When the transistor 274 is switched off, the current in the primary winding stops and magnetic flux in the coupled inductor 278 drops. This induces a voltage across the secondary windings of the coupled inductor 278 which reverses polarity and is positive to the anode of the diode 280, forward-biasing it, and allowing current to flow from the coupled inductor 278 to the capacitor 286. The energy from the coupled inductor core recharges the capacitor 286 and supplies voltage to the output 212.

The voltage across the capacitor 286 is sensed by a voltage sensor 288 and is provided via optocoupler 290 to the flyback controller 270 for controlling the pulse width modulation switching control via conductor 252 to transistor 274. The coupled inductor 278 and the optocoupler 290 provide galvanic isolation between the input to stage 210, namely conductors 240 and 244 and the output 212 to this stage 210, namely conductors 264 and 262. The output 212 is a DC voltage controlled by the controller 270 and which is smoothed by capacitor 286.

It will be readily apparent to persons skilled in the relevant arts that various modifications and improvements may be made to the foregoing embodiments, in addition to those already described, without departing from the basic inventive concepts of the present invention.

1. A power supply device for converting an AC power input into a DC power output, comprising:
a rectifier module connected to the AC power input for producing rectified power;
a final stage DC-DC converter for producing the DC power output; and
one or more smoothing stages provided between the rectifier module and the final stage DC-DC converter to smooth the rectified power; wherein an initial DC-DC converter module is provided between the rectifier module and one of the smoothing stages to lower a voltage range of an output signal from the rectifier module;
wherein the lowered voltage range of the rectified power is provided directly to the final stage DC-DC converter, without a power storage device storing the lowered voltage range of the rectified power.

2. A power supply device according to claim 1, wherein one of the smoothing stages is provided between the initial DC-DC converter module and the final stage DC-DC converter.

3. A power supply device according to claim 1, wherein one or more of the smoothing stages comprises a capacitor.

4. A power supply device according to claim 3, wherein the capacitor is of a small enough value to perform voltage smoothing, but is not large enough to remain substantially charged, when the DC power output is under load and the AC power input is not supplied with an AC power input.

5. A power supply device according to claim 1, wherein the power storage device is a battery.

6. A power supply device according to claim 1, wherein one or both of the initial DC-DC converter module and the final stage DC-DC converter comprises galvanic isolation.

7. A power supply device according to claim 1, wherein the initial DC-DC converter module comprises a buck converter.

8. A power supply device according to claim 1, wherein the final stage DC-DC converter comprises a buck converter.

9. A power supply device according to claim 1, wherein the initial DC-DC convertor module and/or the final stage DC-DC convertor comprises a flyback converter.

10. A power supply device according to claim 1, wherein the initial DC-DC convertor module and/or the final stage DC-DC convertor comprises a push pull converter.

11. (canceled)

12. A power supply device according to claim 1, wherein one of the smoothing stages is provided between the rectifier module and the initial DC-DC converter module.

13. A power supply device according to claim 1, wherein one of the smoothing stages is provided between the final stage DC-DC converter and the DC power output.

14. A power supply device for converting an AC power input into a DC power output to a power consuming device; comprising:
an AC power supply that outputs AC power to a rectifier module that in turn outputs rectified power;
an initial DC-DC converter module that receives the rectified power from the rectifier module as an input, wherein the initial DC-DC converter module outputs a lower peak voltage than the voltage at the input;
a smoothing capacitor connected across the output of the initial DC-DC converter module, wherein the smoothing capacitor smooths the output voltage across the output of the initial DC-DC converter module;
a final stage DC-DC converter that receives the output of the initial DC-DC converter module and further lowers the voltage output, wherein an output of the final stage DC-DC converter provided the DC power output.

15. A power supply device according to claim 14, wherein the output of the final stage DC-DC converter is arranged for charging a battery.

16. A power supply device according to claim 14, wherein the final stage DC-DC converter directly receives the output of the initial DC-DC converter module.

17. A power supply device for converting AC power into DC power, said power supply device comprising:
an AC power input;
a DC power output;
a rectifier module for converting AC power from the AC power input into rectified power;
a first step down DC-DC converter that receives the rectified power;
a second step down DC-DC converter that provides the DC power at a desired voltage to the DC power output;
wherein output from the first step down DC-DC converter is connected to input for the second step down DC-DC converter only by a smoothing circuit that does not retain power over a substantial period of time after the AC power is no longer input.

18. A power supply device according to claim 15, wherein the smoothing circuit comprises a capacitor.

19. A power supply device according to claim 17, wherein one or both of the first and second step down DC-DC converters provides galvanic isolation.

20. A power supply device according to claim 1, wherein the power supply device is a light-weight small portable charger of portable electronic equipment.

21. (canceled)

22. (canceled)

23. A power supply device for converting an AC power supply input into a DC power output to a power consuming device, said power supply device comprising:
an AC power supply input connector that connects to a mains power AC power source of any mains power voltage;
a rectifier module that receives the AC power from the AC power supply input and which outputs rectified power;
an initial stage DC-DC converter module that receives the rectified power from the rectifier module as an input and outputs DC power having a lower voltage than a peak voltage received by the initial stage DC-DC converter module;
a smoothing capacitor connected across the output of the initial stage DC-DC converter module, wherein the smoothing capacitor smooths the output voltage across the output of the initial stage DC-DC converter module;
a final stage DC-DC converter that receives only the smoothed output of the initial stage DC-DC converter module and further lowers the voltage output, wherein an output of the final stage DC-DC converter provides the DC power output to an output connector.
